(19) United States
(12) Patent Application Publication
(10) Pub. No.: US 2025/0242733 A1
(43) Pub. Date: Jul. 31, 2025

(54) OCCUPANT POSTURE REGULATION APPARATUS

(71) Applicant: TOYODA GOSEI CO., LTD., Kiyosu-shi (JP)

(72) Inventor: Masashi HOTTA, Kiyosu-shi (JP)

(21) Appl. No.: 18/999,671

(22) Filed: Dec. 23, 2024

(30) Foreign Application Priority Data
Jan. 30, 2024 (JP) 2024-012325

(51) Int. Cl. B60N 2/427

(52) U.S. Cl. CPC B60N 2/42763

(57) ABSTRACT

Provided is a configuration for reducing a load applied to an occupant when impact occurs. This occupant posture regulation apparatus for regulating a posture of an occupant sitting on a seat 90 when impact occurs on a vehicle includes a lifting element 1 configured to operate when the impact occurs. When the impact occurs, the lifting element 1 lifts a seat surface 93 of the seat 90 upward so that a distance H in a vertical direction between a waist point SW and a chest point SC in a THOR50M dummy 99 sitting on the seat 90 becomes smaller than in a normal case.

### TECHNICAL FIELD

The present disclosure relates to an occupant posture regulation apparatus that is mounted to a vehicle and regulates the posture of an occupant when impact occurs.

### BACKGROUND ART

The following phenomenon is known: when impact occurs on a vehicle upon collision or the like, an occupant sitting on a seat of the vehicle moves frontward or downward even though the occupant is wearing a seat belt.

As used herein, a front side, a frontward direction, and the like mean a front side, a frontward direction, and the like in a front-rear direction with respect to the body of an occupant sitting on a sitting portion of a seat. Similarly, a rear side, a rearward direction, and the like mean a rear side, a rearward direction, and the like in the front-rear direction with respect to the body of the occupant sitting on the sitting portion of the seat. In addition, as used herein, a width direction described later means a horizontal direction that is perpendicular to the front-rear direction. Further, the upward and downward directions mean a vertically upward direction and a vertically downward direction, respectively.

As a kind of the above phenomenon, for example, a phenomenon in which an occupant slips and falls to the front downward side from the seat surface of a seat (so-called submarine phenomenon) is known.

The submarine phenomenon is considered to occur as follows: when impact from the front side is given to a vehicle, the waist of an occupant moves frontward and passes through the underside of a waist strap (also called a waist belt or a wrap strap) for restraining the waist of the occupant, of a seat belt.

In order to suppress such a phenomenon that an occupant moves, proposed is a configuration in which an airbag called a seat cushion airbag is provided under the seat surface of a seat, specifically, inside of a sitting portion (see, for example, Japanese Laid-Open Patent Publication No. 2013-133079; hereinafter, referred to as Patent Literature 1).

In the configuration shown in Patent Literature 1, when impact occurs, the seat cushion airbag is deployed and inflated so

that the seat surface of a seat is raised. Paragraph [0007], etc., in Patent Literature 1 describes that frontward movement of an occupant is inhibited by the seat cushion airbag lifting the thighs of the occupant.

### SUMMARY OF INVENTION

### Technical Problem

Here, for example, even if a conventional seat cushion airbag as shown in Patent Literature 1 operates, an occupant moves frontward when impact occurs. In a case where the occurring impact is great, the occupant greatly moves frontward. In this case, the chest of the occupant is strongly pressed relatively rearward by a seat belt, so that a great load is applied to the occupant.

The inventor of the present disclosure conducted thorough studies in order to inhibit the above problem that the chest of an occupant is strongly pressed when impact occurs. As a result, the inventor has found that the problem that the chest of an occupant is strongly pressed when impact occurs is relevant to the posture of the occupant when impact occurs.

When impact occurs, the waist of the occupant's body is restrained by a waist strap of the seat belt and the shoulder is restrained by a shoulder strap of the seat belt. At this time, when the conventional seat cushion airbag operates, the thighs of the occupant are lifted, whereby the above submarine phenomenon or the like is considered to be inhibited.

However, even in the state in which the occupant is restrained by the seat belt and the seat cushion airbag operates as described above, a great force directed frontward acts on the occupant. Since the waist of the occupant is fixed by the waist strap so as not to move frontward, the upper body of the occupant greatly collapses frontward when impact is great. Then, at this time, the shoulder strap is fitted along the chest of the occupant, i.e., a part between the shoulder and the waist, so that the chest of the occupant is greatly pressed by tension of the shoulder strap.

The inventor of the present disclosure considered that the shoulder strap coming into a state of being fitted along the chest of the occupant causes a problem that the chest of the occupant is strongly pressed, and aimed at regulating the posture of the occupant so that the shoulder strap does not come into a state of being fitted along the chest of the occupant, thus completing the present disclosure.

The present disclosure has been made in view of the above circumstances, and an object of the present disclosure is to provide a configuration that reduces a load applied to an occupant when impact occurs.

### Solution to Problem

In order to achieve the above object, an occupant posture regulation apparatus according to the present disclosure is an occupant posture regulation apparatus for regulating a posture of an occupant sitting on a seat when impact occurs on a vehicle, the occupant posture regulation apparatus including a lifting element configured to operate when the impact occurs. When the impact occurs, the lifting element lifts a seat surface of the seat upward so that a distance in a vertical direction between a waist point and a chest point in a THOR50M dummy sitting on the seat becomes smaller than in a normal case.

The occupant posture regulation apparatus according to the present disclosure reduces a load applied to an occupant when impact occurs.

### BRIEF DESCRIPTION OF DRAWINGS

FIG. 1 schematically illustrates a state where an occupant posture regulation apparatus according to embodiment 1 is seen from above;

FIG. 2 schematically illustrates a state where the occupant posture regulation apparatus according to embodiment 1 is seen laterally;

FIG. 3 schematically illustrates a state where the occupant posture regulation apparatus according to embodiment 1 is seen laterally;

FIG. 4 schematically shows a state where an airbag of the occupant posture regulation apparatus according to embodiment 1 is seen from above;

FIG. 5 schematically shows a state where the airbag of the occupant posture regulation apparatus according to embodiment 1 is seen laterally;

FIG. 6 schematically illustrates a state where the airbag of the occupant posture regulation apparatus according to embodiment 1 is seen laterally from the rear side;

FIG. 7 schematically illustrates a state where an occupant posture regulation apparatus according to embodiment 2 is seen laterally;

FIG. 8 schematically illustrates a state where an occupant posture regulation apparatus according to embodiment 3 is seen laterally;

FIG. 9 schematically illustrates an occupant posture regulation apparatus according to embodiment 4;

FIG. 10 schematically illustrates an example of an airbag of the occupant posture regulation apparatus according to the present disclosure;

FIG. 11 schematically illustrates the example of an airbag of the occupant posture regulation apparatus according to the present disclosure;

FIG. 12 schematically illustrates an example of an airbag of the occupant posture regulation apparatus according to the present disclosure;

FIG. 13 schematically illustrates the example of the airbag of the occupant posture regulation apparatus according to the present disclosure;

FIG. 14 schematically illustrates an example of an airbag of the occupant posture regulation apparatus according to the present disclosure;

FIG. 15 schematically illustrates the example of the airbag of the occupant posture regulation apparatus according to the present disclosure;

FIG. 16 schematically illustrates an example of an airbag of the occupant posture regulation apparatus according to the present disclosure; and

FIG. 17 schematically illustrates state where a conventional seat and a dummy sitting on the seat are seen laterally.

### DESCRIPTION OF EMBODIMENTS

As described above, the inventor of the present disclosure considered that the problem that the chest of an occupant is strongly pressed by a shoulder strap of a seat belt when impact occurs is relevant to the posture of the occupant when impact occurs.

A case where an occupant sitting on a seat is replaced with a dummy sitting on the seat will be described.

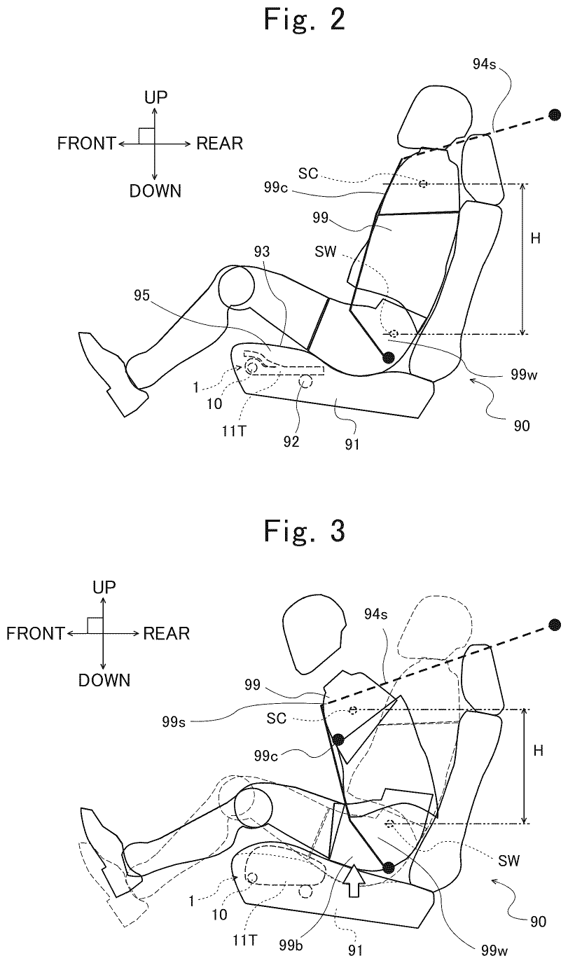

For example, as shown in FIG. 2, a shoulder strap 94s of a seat belt 94 is stretched along a chest 99c from a shoulder 99s to a waist 99w of a dummy 99 sitting on a seat 90.

For example, when impact occurs, a conventional seat cushion airbag device 101 shown in FIG. 17 operates, so that the thighs of the dummy 99 are lifted, but the upper body of the dummy 99 collapses frontward, so that a shoulder strap 194s of a seat belt 194 strongly restrains the chest 99c of the dummy 99. Thus, the chest 99c of the dummy 99 is strongly pressed by the shoulder strap 194s.

While advancing the above consideration, the inventor came up with an idea that, when impact occurs, if the shoulder strap does not come into a state of being fitted along the chest of the occupant, the chest of the occupant is prevented from being strongly pressed by the shoulder strap.

The occupant posture regulation apparatus according to the present disclosure regulates the posture of the occupant sitting on the seat when impact occurs on a vehicle, thereby preventing the shoulder strap from coming into a state of being fitted along the chest of the occupant when impact occurs.

The occupant posture regulation apparatus according to the present disclosure includes a lifting element which operates when impact occurs on a vehicle. When impact occurs, the lifting element lifts the seat surface of the seat upward so that the shoulder strap does not come into a state of being fitted along the chest of the occupant. More specifically, the lifting element lifts the seat surface of the seat upward so that the distance in the vertical direction between a waist point and a chest point in a THOR50M dummy sitting on the seat becomes smaller than in a normal case.

The THOR50M dummy is a kind of a dummy figure for an impact safety test.

The THOR50M dummy has a part corresponding to the waist of the occupant and a part corresponding to the chest of the occupant. As used herein, in the THOR50M dummy, a predetermined point in the part corresponding to the waist of the occupant is referred to as a waist point, and a predetermined point in the part corresponding to the chest of the occupant is referred to as a chest point.

The THOR50M dummy has a waist acceleration sensor at the part corresponding to the waist of the occupant, and a chest acceleration sensor at the part corresponding to the chest of the occupant, more specifically, at a point corresponding to the fourth thoracic vertebra of a human body, i.e., the occupant, in the THOR50M dummy. Therefore, the waist point may be rewritten as the waist acceleration sensor, and the chest point may be rewritten as the chest acceleration sensor.

When the vehicle collides, the THOR50M dummy sitting on the seat of the vehicle exhibits a behavior similar to that of the occupant sitting on the seat.

In a situation in which, when the THOR50M dummy is sitting on the seat of the vehicle, the distance in the vertical direction between the waist point and the chest point in the THOR50M dummy becomes smaller than in a normal case, the distance in the vertical direction between the waist and the chest of the occupant sitting on the seat becomes shorter than in a normal case. In other words, in this situation, the occupant sitting on the seat comes into a so-called stooped state in which the back is bowed frontward.

When the occupant is in the stooped state, the shoulder strap is stretched between the shoulder and the waist of the occupant without coming into a state of being fitted along the chest of the occupant. Therefore, at this time, a gap is formed between the shoulder strap and the chest located between the shoulder and the waist. Thus, the chest of the occupant is prevented or inhibited from being strongly pressed by tension of the shoulder strap. That is, the occupant posture regulation apparatus according to the present disclosure reduces a load applied to the occupant when impact occurs.

Hereinafter, as necessary, the THOR50M dummy may be simply referred to as a dummy, and the distance in the vertical direction between the waist point and the chest point may be referred to as an inter-point distance in the vertical direction. In addition, as necessary, that the inter-point distance in the vertical direction in the dummy sitting on the seat becomes smaller than in a normal case may be described as “the dummy comes into a stooped state on the seat”.

Further, the part corresponding to the waist of the occupant, the part corresponding to the chest of the occupant, and the like in the dummy are referred to as a waist of the dummy, a chest of the dummy, and the like. The same applies to other parts of the dummy that correspond to parts of the occupant.

Hereinafter, the occupant posture regulation apparatus according to the present disclosure will be described for each component thereof.

The occupant posture regulation apparatus according to the present disclosure may include at least the lifting element, and may include other components, e.g., a seat belt, a seat, and the like.

Unless otherwise specified, a numerical value range “x to y” described herein includes, in the range thereof, a lower limit x and an upper limit y. A new numerical value range may be formed by optionally combining the upper limit values and the lower limit values, and numerical values described in the embodiments. Numerical values optionally selected from any of the numerical value ranges may be used as the upper and lower limit values in a new numerical value range.

The occupant posture regulation apparatus according to the present disclosure includes the lifting element which operates when impact occurs on the vehicle.)

As described above, the lifting element may be configured to, when impact occurs, lift the seat surface of the seat upward so that the dummy comes into a stooped state on the seat, and the details of the lifting element is not particularly limited.

Here, the inventor of the present disclosure obtained knowledge that, in order to bring the dummy into a stooped state on the seat when impact occurs, lifting the buttocks of the dummy is effective, instead of lifting the thighs of the dummy.

In a case of lifting the thighs of the dummy, the thighs of the dummy are simply lifted and the dummy collapses frontward. Therefore, in this case, the backbone of the dummy is unlikely to bow and thus is unlikely to come into a stooped state.

On the other hand, in a case of lifting the buttocks of the dummy, a force directed from the lower side to the upper side acts on the backbone of the dummy. Since the distance in the vertical direction between the buttocks of the dummy and the lifting element which is a generation source for the force is very short, the force directly acts on the buttocks of the dummy and the speed of lifting of the buttocks is fast. However, to a part of the dummy at a long distance in the vertical direction from the lifting element, the force transfers while being damped via the backbone of the dummy. Therefore, as the part of the dummy becomes farther in the vertical direction from the lifting element, the speed of lifting of the part becomes slow and the amount of lifting of the part is also reduced. The waist of the dummy is closer to the buttocks of the dummy than the shoulders of the dummy are, and the dummy collapses frontward when impact occurs. Therefore, when the buttocks of the dummy are lifted, the shoulders of the dummy come close to the waist of the dummy, so that the dummy comes into a stooped state.

The dummy exhibits a behavior similar to the occupant. Therefore, if, when impact occurs, the buttocks of the dummy sitting on the seat are lifted and the dummy is successfully brought into a stooped state, the occupant sitting on the seat is similarly brought into a stooped state. As a result, the chest of the occupant is prevented or inhibited from being strongly pressed by tension of the shoulder strap. Thus, a load applied to the occupant when impact occurs is reduced.

The distance in the vertical direction between the waist point and the chest point, e.g., the distance in the vertical direction between the waist acceleration sensor and the chest acceleration sensor, may be smaller when impact occurs than in a normal case. In other words, at this time, the dummy takes a frontward leaning posture, and the distance in the vertical direction between the waist point and the chest point becomes shorter when impact occurs than in a normal case, i.e., before impact occurs. Preferably, a distance by which the waist point and the chest point come close to each other in the vertical direction is not less than 10 mm, not less than 20 mm, or not less than 30 mm.

The above normal case means, more specifically, a state in which the dummy is normally sitting. As described above, the waist point and the chest point may be rewritten as the waist acceleration sensor and the chest acceleration sensor in the dummy.

The above “distance in the vertical direction between the waist point and the chest point when impact occurs” may be measured under a condition compliant with a frontal collision test prescribed in the US New Car Assessment Program (US NCAP). For reference, the frontal collision test in the US NCAP is a full-wrap frontal collision test, i.e., a frontal collision test in which a test vehicle with dummies sitting on a driver seat and a passenger seat is driven to collide with a concrete wall (fixed barrier) by the entire frontal part at a vehicle speed of 56 km/h.

In order to efficiently or reliably lift the buttocks of the dummy sitting on the seat and bring the dummy into a stooped state when impact occurs, the lifting element preferably satisfies one of the following [1] to [3] and more preferably satisfies a plurality of the following [1] to [3].
[1] Quickly lift the buttocks of the dummy when impact occurs.
[2] Lift the buttocks of the dummy from directly below when impact occurs.
[3] Lift the buttocks of the dummy high when impact occurs.

When impact occurs, in order to quickly lift the buttocks of the dummy by the lifting element [1], the lifting element preferably lifts the seat surface of the seat upward at such a speed that the waist point (e.g., the waist acceleration sensor) in the dummy is lifted by not less than 10 mm in 25 milliseconds when impact occurs. More preferably, the lifting element lifts the seat surface of the seat upward at such a speed that the waist point is lifted by not less than 20 mm in 25 milliseconds.

An example of the lifting element that quickly lifts the buttocks of the dummy as described in the above [1] is a seat cushion airbag device provided under the seat surface in the seat.

When impact occurs, the seat cushion airbag device is deployed and expanded to lift the seat surface of the seat, thereby lifting the buttocks of the dummy. The seat cushion airbag device has an airbag having a bag shape, and an inflation fluid production source which is connected to the airbag and supplies an inflation fluid to the airbag. Hereinafter, unless otherwise specified, an airbag as used herein means the airbag of the seat cushion airbag device.

As the inflation fluid production source, a so-called inflator for producing gas as an inflation fluid is preferably used. In some cases, means for producing an inflation fluid other than gas, e.g., liquid or gel, may be used.

The inflation fluid production source may be any device for supplying the inflation fluid to the airbag, and may be a so-called pyro-type inflator having a gas-producing agent for producing gas as the inflation fluid, for example. Alternatively, the inflation fluid production source may be a so-called hybrid-type inflator of which a high-pressure container has a cutaway partition wall and which supplies gas stored in the high-pressure container. The entirety of the inflation fluid production source may be located outside the airbag, or a part or the entirety thereof may be located inside the airbag.

The inflation fluid production source quickly starts to supply the inflation fluid to the airbag and supplies the inflation fluid at a comparatively high flow rate. Thus, the seat cushion airbag device as the lifting element quickly lifts the seat surface upward when impact occurs, and therefore quickly lifts the buttocks of the dummy.

The airbag is provided at the sitting portion of the seat for vehicle. The sitting portion is a part of the seat on which the occupant is sitting, and may include a seat support portion and a cushion-like seat portion supported by the seat support portion. The seat may include a backrest, an armrest, and the like, in addition to the sitting portion.

As used herein, the seat may be any seat that allows the occupant to sit thereon, and may be a front seat such as a driver seat or a passenger seat or may be a rear seat.

The airbag is provided under the seat surface in the sitting portion of the seat for vehicle. When being deployed and expanded, the airbag deforms and pushes the seat surface of the sitting portion in the upward direction.

Preferably, the airbag is stored in the sitting portion such that the airbag is folded or collapsed, in a normal state. As a material of the airbag, a material that is foldable and deployable is preferably selected.

As a specific material of the airbag, a flexible and high-strength material is preferably selected, and for example, a woven fabric made of a high-strength resin fiber such as polyester or polyamide is particularly preferably used.

In a case of using the seat cushion airbag device as the lifting element, depending on the position of the airbag relative to the sitting portion, the buttocks of the dummy are lifted from directly below as described in the above [2]. As used herein, the wording “directly below” not only means a direction vertically downward of the buttocks of the dummy but also includes a direction within an angle range of 30° relative to the vertically downward direction.

Specifically, the position of the airbag relative to the seat is desirably a position that is under the seat surface of the seat and between a center and a front end in the front-rear direction in the sitting portion of the seat.

In a case where the position of the airbag is the above-described position, as the airbag is deployed and expanded, an area between the center and the front end in the front-rear direction in the sitting portion deforms upward. In the sitting portion, at least a part of the area between the center and the front end in the front-rear direction coincides with an area from the hip bone to the thighs of the dummy sitting on the seat. Therefore, at this time, the area from the hip bone to the thighs of the dummy sitting on the sitting portion of the seat, i.e., the buttocks, is lifted from directly below. Similarly, at this time, the buttocks of the occupant sitting on the sitting portion of the seat are lifted from directly below.

More preferably, the position of the airbag relative to the sitting portion is on the rear side from a front-side ⅕ position in the front-rear direction in the sitting portion, on the rear side from a front-side ¼ position in the front-rear direction in the sitting portion, or on the rear side from a front-side ⅓ position in the front-rear direction in the sitting portion. In these cases, the airbag is located near the buttocks of the dummy sitting on the seat, and therefore the buttocks of the dummy are lifted from directly below when impact occurs.

In order to lift the buttocks of the dummy high when impact occurs as described in the above [3], preferably, the airbag in the seat cushion airbag device which is the lifting element is greatly deformed in the upward direction when being deployed and expanded, and the position in the upward direction of a top portion is made high to a certain extent.

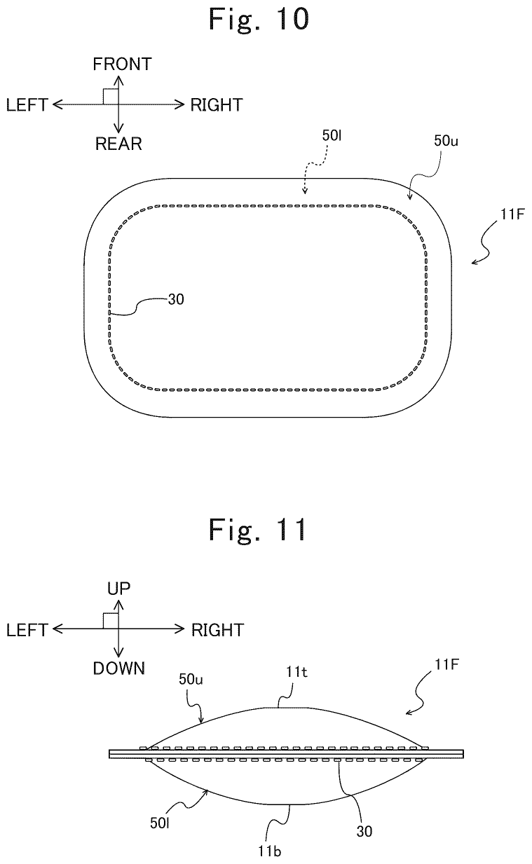

An airbag of a general seat cushion airbag device has a flattened shape obtained by sewing together an upper sheet 50u forming a top portion 11t of the airbag and a lower sheet 501 forming a bottom portion of the airbag, as shown in FIG. 10 and FIG. 11. In the airbag, seams between the upper sheet 50u and the lower sheet 501 are formed around the entire periphery in the peripheral direction along peripheral edges of the upper sheet 50u and the lower sheet 501. Hereinafter, as necessary, the airbag is referred to as a flattened-type airbag.

The above-described flattened-type airbag 11F has a flattened shape with almost no thickness in the up-down direction, in a normal state, i.e., a state of not being deployed or expanded. Then, as shown in FIG. 11, when impact occurs and the flattened-type airbag 11F is deployed and expanded, the lower sheet 501 is swelled downward so that a bottom portion 11b is formed, and subsequently, the upper sheet 50u is swelled upward so that the top portion 11t is formed.

In order to greatly deform this type of flattened-type airbag 11F in the upward direction at the time of deployment and expansion so that the position in the upward direction of the top portion 11t becomes high to a certain extent, the outer shape of the flattened-type airbag 11F needs to be large.

Specifically, in a normal state, the size of the flattened-type airbag in the width direction of the sitting portion of the seat is preferably not less than 80% of the width-direction length of the sitting portion, and more preferably not less than 90% thereof.

As described above, the flattened-type airbag used for the seat cushion airbag device which is the lifting element needs to have a large outer shape in a normal state. However, depending on the shape of the sitting portion of the seat, there may be difficulty in placing such a large-sized flattened-type airbag.

That is, in order to enhance the degree of freedom in placing the airbag, using such an airbag that is greatly deformed in the upward direction when being deployed and expanded even in a case where the outer shape thereof in a normal state is not so large is considered preferable.

Specifically, the above airbag is preferably formed in such a shape that has a side portion between the top portion and the bottom portion when being deployed and expanded. More preferably, the airbag has standing walls extending in the up-down direction, in at least two opposing areas of the side portion.

Hereinafter, as necessary, the airbag is referred to as a three-dimensional airbag.

The three-dimensional airbag is considered to be a seat cushion airbag connected to an inflation fluid production source and configured to be deployed and expanded with an inflation fluid supplied to the inside of the seat cushion airbag, the seat cushion airbag having, when being deployed and expanded, a side portion between a top portion and a bottom portion, and standing walls extending in the up-down direction in at least two opposing areas of the side portion.

In the three-dimensional airbag, the standing walls included in the side portion extend in the up-down direction at the time of deployment and expansion. Therefore, the standing walls guide the deformation direction of the airbag so that the position in the upward direction of the top portion becomes high at the time of deployment and expansion.

The standing walls are considered to contribute to greatly deforming the airbag in the upward direction at the time of deployment and expansion.

In the case of the three-dimensional airbag having such standing walls at the side portion, even if the outer shape of the airbag in a normal state is not so large, the position in the upward direction of the top portion becomes sufficiently high at the time of deployment and expansion. Thus, in a case of using the seat cushion airbag device having the three-dimensional airbag as the lifting element, the buttocks of the dummy sitting on the seat are lifted high when impact occurs, and thus the dummy is efficiently brought into a stooped state.

In the three-dimensional airbag, the side portion may be formed only at the time of deployment and expansion or may be formed in a normal case as well as at the time of deployment and expansion.

Here, the top portion of the three-dimensional airbag means, of the three-dimensional airbag mounted to the sitting portion of the seat, an area including an upper end portion at the time of deployment and expansion, and a peripheral edge formed around the upper end portion and smoothly contiguous to the upper end portion. The size and the shape of the top portion may have any shape in accordance with the shape of the three-dimensional airbag, and may be a line shape or a surface shape.

The top portion of the three-dimensional airbag may extend three-dimensionally in the up-down direction, and the length in the up-down direction of the top portion differs variously in accordance with the shape of the three-dimensional airbag and therefore is not particularly limited. The side portion including the standing walls may be formed contiguously to the top portion, and the boundary between the top portion, and the side portion or the standing walls, may be unclear.

Meanwhile, the bottom portion means, of the three-dimensional airbag mounted to the sitting portion, an area including a lower end portion at the time of deployment and expansion, and a peripheral edge formed around the lower end portion and smoothly contiguous to the lower end portion. The size and the shape of the bottom portion may have any shape in accordance with the shape of the three-dimensional airbag, and may be a line shape or a surface shape.

The bottom portion may extend three-dimensionally in the up-down direction, and the length in the up-down direction of the bottom portion differs variously in accordance with the shape of the three-dimensional airbag and therefore is not particularly limited. The side portion including the standing walls may be formed contiguously to the bottom portion, and the boundary between the bottom portion, and the side portion or the standing walls, may be unclear.

The side portion of the three-dimensional airbag is present between the top portion and the bottom portion described above, at the time of deployment and expansion. At the time of deployment and expansion, the top portion and the bottom portion are present at positions different in the up-down direction. Therefore, the side portion is considered to be present between the top portion and the bottom portion in the up-down direction of the three-dimensional airbag. The side portion is present between the top portion and the bottom portion around the entire periphery in the peripheral direction of the three-dimensional airbag.

As used herein, the peripheral direction of the three-dimensional airbag means a direction in which the side portion extends in the three-dimensional airbag.

The flattened-type airbag also has the top portion, the bottom portion, and the side portion described above.

The three-dimensional airbag has standing walls extending in the up-down direction, in at least two opposing areas of the side portion.

The standing walls of the three-dimensional airbag may form only a part of the side portion, or may form the entirety of the side portion. In other words, the standing walls may be present between the top portion and the bottom portion, only at a part in the peripheral direction of the three-dimensional airbag, or may be present between the top portion and the bottom portion, around the entire periphery in the peripheral direction of the three-dimensional airbag.

The standing walls of the three-dimensional airbag are considered to be formed in a gusset shape, i.e., a shape of a so-called insert cloth added to a part where the thickness is insufficient in the flattened-type airbag formed by only the upper sheet and the lower sheet.

For example, the standing walls of the three-dimensional airbag may be formed integrally with the top portion and/or the bottom portion. Alternatively, the standing walls may be formed separately from the top portion and/or the bottom portion, and then may be integrated by being pieced together with the top portion and/or the bottom portion.

As used herein, piecing together is a concept including sewing together by a thread, binding together using any joining member such as a staple of a stapler, bonding by an adhesive, and welding.

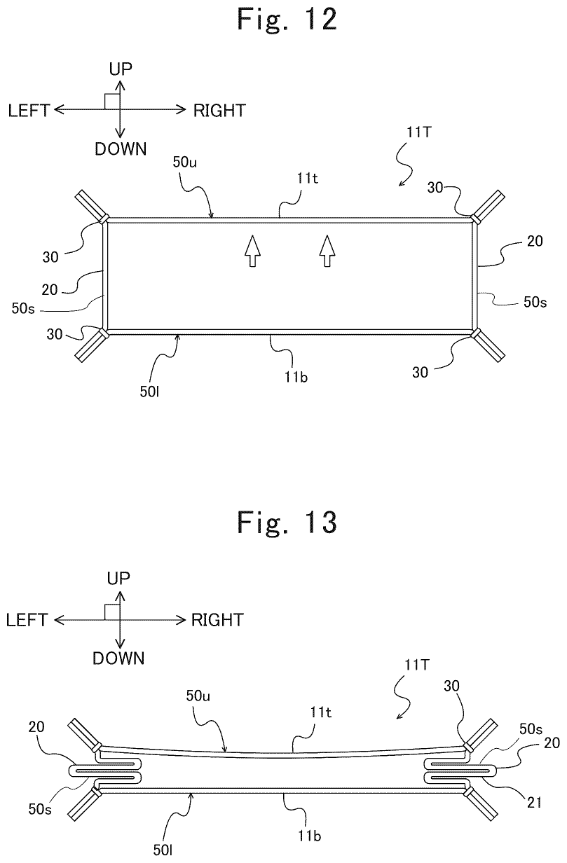

For example, as shown in FIG. 12 and FIG. 13, the three-dimensional airbag 11T may be formed such that gusset members 50s which are separate from the upper sheet 50u and the lower sheet 501 are pieced together with the upper sheet 50u and the lower sheet 501 so as to be integrated. When the three-dimensional airbag 11T is deployed and expanded, the standing walls 20 are formed by parts of the gusset members 50s.

FIG. 12 and FIG. 13 schematically illustrate an example of the three-dimensional airbag, and more specifically, schematically illustrate a state where the three-dimensional airbag is cut along the width direction, i.e., the left-right direction shown in the drawings.

The three-dimensional airbag 11T shown in FIG. 12 is folded or collapsed as shown in FIG. 13, in a normal state. The three-dimensional airbag 11T is deployed and expanded as shown in FIG. 12, by being supplied with the inflation fluid from the inflation fluid production source (not shown).

As shown in FIG. 12, in the three-dimensional airbag 11T, the standing walls 20 extend in the up-down direction at the time of deployment and expansion. Thus, the standing walls 20 guide the deformation direction of the three-dimensional airbag 11T so that the position in the upward direction of the top portion 11t becomes high.

As shown in FIG. 12 and FIG. 13, in the three-dimensional airbag 11T, joints (specifically, seams 30) between the standing walls 20 and the top portion 11t are present at upper ends of the standing walls 20, and joints (i.e., seams 30) between the standing walls 20 and the bottom portion 11b are present at lower ends of the standing walls 20. The joints between the standing walls 20 and the top portion 11t may be rewritten as joints between the gusset members 50s and the upper sheet 50u. The joints between the standing walls 20 and the bottom portion 11b may be rewritten as joints between the gusset members 50s and the lower sheet 501.

Of the standing wall 20, a part located near the joint 30 has higher rigidity than the other part (referred to as a general portion 21 of the standing wall 20, as necessary) of the standing wall 20. Therefore, as compared to the general portion of the standing wall 20, the joint-neighboring part of the standing wall 20 is less likely to deform and thus the shape thereof is likely to be kept.

Accordingly, in the three-dimensional airbag 11T in this example, at the time of deployment and expansion, the general portions 21 of the standing walls 20 preferentially deform to guide the deformation direction of the three-dimensional airbag 11T so that the position in the upward direction of the top portion 11t becomes high.

Therefore, in this case, even if the outer shape of the three-dimensional airbag 11T in a normal state is not so large, the position in the upward direction of the top portion 11t becomes sufficiently high at the time of deployment and expansion.

In this example, substantially the entirety of the upper sheet 50u forms the top portion 11t of the three-dimensional airbag 11T.

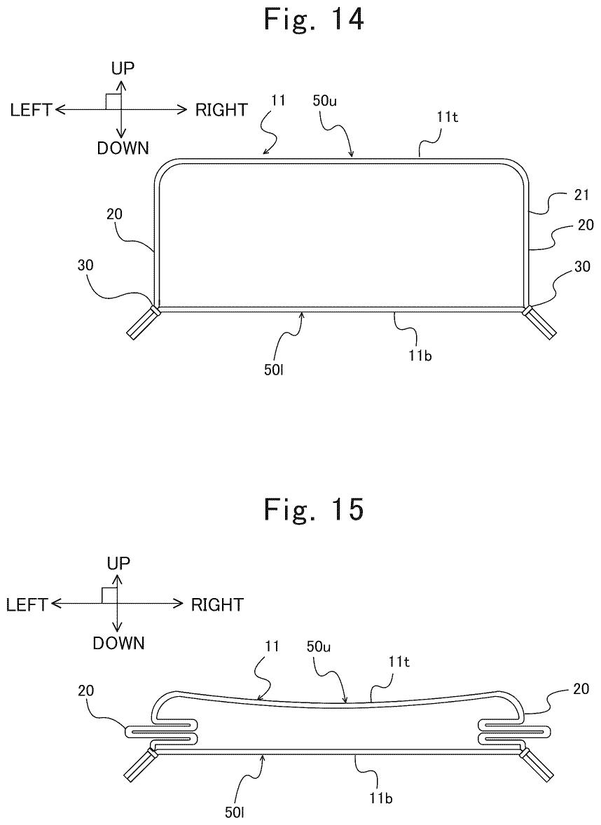

In another example, as shown in FIG. 14, the gusset members 50s and the upper sheet 50u of the three-dimensional airbag 11T may be formed integrally, and the lower sheet 501 and the integrally formed unit of the upper sheet 50u and the standing walls 20 may be sewed together so as to be integrated.

In the three-dimensional airbag 11T in this example, the standing walls 20 are considered to be formed by parts of the upper sheet 50u.

Also in this example, the standing walls 20 are considered to serve as gussets between the top portion 11t and the bottom portion 11b.

For reference, FIG. 14 and FIG. 15 schematically illustrate the example of the three-dimensional airbag, and more specifically, schematically illustrate a state where the three-dimensional airbag is cut along the width direction.

The three-dimensional airbag 11T in this example is folded or collapsed as shown in FIG. 15, in a normal state. Then, when being supplied with the inflation fluid from the inflation fluid production source (not shown), the three-dimensional airbag 11T is deployed and expanded as shown in FIG. 14.

As shown in FIG. 15, in the three-dimensional airbag 11T, at the time of deployment and expansion, the standing walls 20 which are parts of the upper sheet 50u and extend in the up-down direction guide the deformation direction of the three-dimensional airbag 11T in the up-down direction so that the position in the upward direction of the top portion 11t which is another part of the upper sheet 50u becomes high.

Therefore, also in this case, even if the internal pressure of the three-dimensional airbag 11T at the time of deployment and expansion is not so high, the position in the upward direction of the top portion 11t becomes sufficiently high. Thus, not only the height of the three-dimensional airbag 11T deployed and expanded when impact occurs becomes sufficiently great, but also the speed at which the height of the three-dimensional airbag 11T increases when impact occurs becomes fast, leading to an advantage that the buttocks of the dummy are quickly lifted when impact occurs.

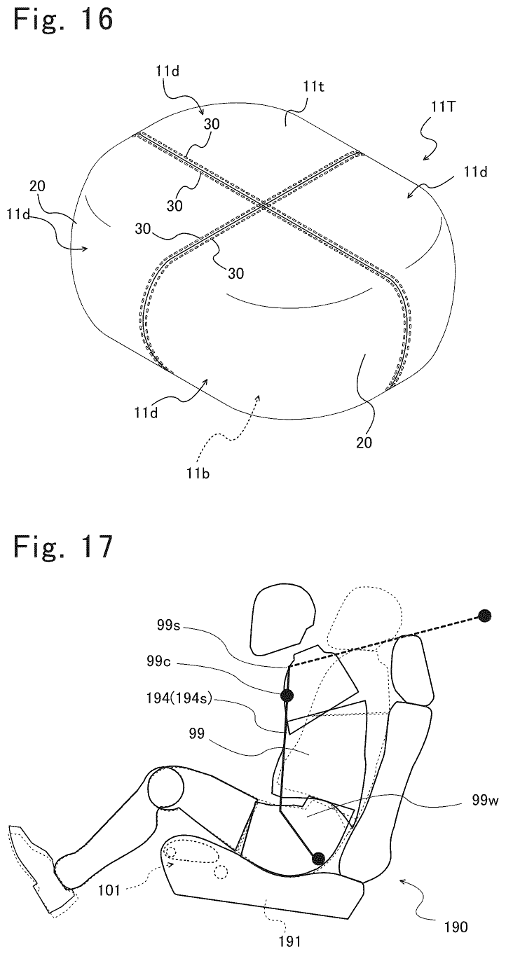

In still another example, as shown in FIG. 16, the top portion 11t, the bottom portion 11b, and the standing wall 20 of the three-dimensional airbag 11T may be divided into a plurality of divisional bodies. Then, the divisional body of the top portion 11t, the divisional body of the standing wall 20 contiguous to the divisional body of the top portion 11t, and the divisional body of the bottom portion 11b contiguous to the divisional body of the standing wall 20, may be formed integrally to form one airbag divisional body 11d.

In the three-dimensional airbag 11T in this example, four airbag divisional bodies 11d are considered to be pieced together so as to be integrated, thus forming the three-dimensional airbag 11T.

The top portion 11t of the three-dimensional airbag 11T in this example has joints 30 between a part of each airbag divisional body 11d that forms the top portion 11t and a part of another adjacent airbag divisional body 11d that forms the top portion 11t.

The bottom portion 11b of the three-dimensional airbag 11T in this example has joints 30 between a part of each airbag divisional body 11d that forms the bottom portion 11b and a part of another adjacent airbag divisional body 11d that forms the bottom portion 11b.

The standing wall 20 of the three-dimensional airbag 11T in this example has joints 30 between a part of each airbag divisional body 11d that forms the standing wall 20 and a part of another adjacent airbag divisional body 11d that forms the standing wall 20.

Also in this case, when the three-dimensional airbag 11T folded or collapsed in a normal state is deployed and expanded, the standing wall extending in the up-down direction guides the deformation direction of the three-dimensional airbag 11T so that the position in the upward direction of the top portion 11t becomes high.

Therefore, also in this case, even if the outer shape of the three-dimensional airbag in a normal state is not so large, the position in the upward direction of the top portion of the three-dimensional airbag at the time of deployment and expansion becomes sufficiently high.

In a normal state, the standing wall is preferably folded to the inner side or the outer side of the three-dimensional airbag. This provides an advantage that, at the time of deployment and expansion, the length of the standing wall in the up-down direction is easily increased, and in a normal state, the three-dimensional airbag is easily collapsed or folded so that the outer shape thereof is reduced.

In the case where the standing wall is folded to the inner side or the outer side of the three-dimensional airbag in a normal state as described above, a seam or a joint is preferably formed at a crease part of the standing wall. Thus, rigidity at the crease part is increased, and in a normal state, the shape of the crease is easily kept.

The three-dimensional airbag may have the standing walls extending in the up-down direction, in at least two opposing areas of the side portion, and the lengths of the standing walls in the up-down direction are not particularly limited. Each standing wall may be formed continuously over the entire range in the up-down direction, or may have a joint at any part in the up-down direction.

In the three-dimensional airbag, in order to cause the position in the upward direction of the top portion to be higher at the time of deployment and expansion, the lengths in the up-down direction of the standing walls, i.e., the heights of the standing walls, are preferably set to be great.

The lengths in the up-down direction of the standing walls of the three-dimensional airbag are preferably not less than 120 mm at the time of deployment and expansion, in a case where the internal pressure is 175 kPa. The lengths in the up-down direction of the standing walls are not particularly limited, but as an example, the lengths may be not greater than 300 mm.

In a case where the three-dimensional airbag has the standing walls in two opposing areas of the side portion, the standing walls in the two areas may have the same shape or different shapes. The lengths in the up-down direction of the standing walls in this case may be the same or different from each other.

In a case where the standing wall is formed around the entire periphery in the peripheral direction of the three-dimensional airbag, the length in the up-down direction of the standing wall may be the same around the entire periphery in the peripheral direction, or may vary. In order to inhibit the above-described submarine phenomenon, length in the up-down direction at a front side part of the standing wall is preferably greater than the length in the up-down direction at a rear side part.

As described above, the standing wall may be formed integrally with the top portion and/or the bottom portion, but preferably, the standing wall formed separately from the top portion and the bottom portion is pieced together with the top portion and/or the bottom portion so as to be integrated. When the general portion of the standing wall is interposed between high-rigidity parts, i.e., the joint of the top portion and the standing wall and the joint of the bottom portion and the standing wall, a force of the general portion deforming in the up-down direction at the time of deployment and expansion is less likely to be transferred from the general portion to the top portion side and from the general portion to the bottom portion side. For example, at the time of deployment and expansion, if the general portion deforms in the up-down direction, the upper sheet and the lower sheet bend accordingly. If the upper sheet and the lower sheet bend as described above, deformation in the up-down direction of the general portion is hampered.

When the general portion is interposed between the joints, deformation of the general portion in the up-down direction is less likely to be hampered. Therefore, even if the internal pressure at the time of deployment and expansion is comparatively low, the length in the up-down direction of the three-dimensional airbag becomes sufficiently great, and the speed at which the three-dimensional airbag rises upward when impact occurs is fast. Thus, when impact occurs, the buttocks of the dummy are lifted high and quickly.

Also in the three-dimensional airbag, in order to lift the buttocks of the dummy sitting on the seat high, the length in the width direction of the three-dimensional airbag is preferably set to be great to a certain extent.

Specifically, in a normal state, the length of the three-dimensional airbag in the width direction is preferably not less than 280 mm. Alternatively, the size of the three-dimensional airbag in a normal state is preferably not less than 70% in a case where the width-direction length of the sitting portion is defined as 100%.

The length in the front-rear direction of the three-dimensional airbag is not particularly limited, and may be approximately equal to the length in the width direction or may be greater than the length in the width direction. However, if the three-dimensional airbag has a compact size, the weight of the three-dimensional airbag is reduced.

Therefore, the length in the front-rear direction of the three-dimensional airbag is preferably smaller than the length in the width direction. In other words, preferably, the three-dimensional airbag has a long-side direction and a short-side direction, and the long-side direction is along the width direction of the sitting portion.

Specifically, the length of the three-dimensional airbag in the front-rear direction is preferably not less than 25% of the length of the three-dimensional airbag in the width direction.

In order to lift the buttocks of the dummy sitting on the seat high, at the time of deployment and expansion, areas of the three-dimensional airbag that correspond to the buttocks of the dummy or outer sides in the width direction from the buttocks are preferably at a higher position in the upward direction as compared to an area corresponding to the hip bone of the dummy.

In other words, preferably, the three-dimensional airbag is provided at the sitting portion such that the long-side direction of the three-dimensional airbag is along the width direction of the sitting portion, and the top portion of the three-dimensional airbag has rising portions at both ends in the long-side direction. The rising portions are considered to be at higher positions in the upward direction than a center part in the long-side direction, at the time of deployment and expansion.

Specifically, in the three-dimensional airbag, each rising portion and the center part in the long-side direction are preferably separate from each other in the up-down direction by not less than 5 mm, at the time of deployment and expansion.

In the three-dimensional airbag, the top portion and the bottom portion may be connected by a tether. The tether is a member having a string shape, a band shape, a thread shape, or the like, and is also called a connection rope or a strap. Connecting the top portion and the bottom portion by the tether enables the position in the upward direction of the top portion to be controlled with high accuracy at the time of deployment and expansion. This is useful for lifting the buttocks of the dummy sitting on the seat.

Similarly, the opposing standing walls of the three-dimensional airbag, in other words, the paired standing walls, are preferably connected by a tether. Connecting the standing walls by the tether provides an advantage that the relative positions of the standing walls are controlled with high accuracy at the time of deployment and expansion.

In the three-dimensional airbag in this example, particularly preferably, the standing walls are present at both ends in the long-side direction of the three-dimensional airbag, and the long-side direction of the three-dimensional airbag is along the width direction of the sitting portion.

In this case, the length in the width direction of the three-dimensional airbag at the time of deployment and expansion is controlled with high accuracy, whereby the buttocks of the dummy sitting on the seat are lifted high.

In order to lift the buttocks of the dummy from directly below when impact occurs [2], using at least a part of the sitting portion of the seat as a part of the lifting element is effective.

For example, the lifting element may have the seat portion including the seat surface of the seat. In this case, at least a part of the seat portion may change in position upward when impact occurs.

As described above, the seat portion is a part of the sitting portion of the seat and is a part supported by the seat support portion which is also a part of the sitting portion. The seat portion has a cushion shape and includes the seat surface. The seat portion is considered to be a part with which the buttocks of the occupant contact.

The seat portion may be formed of one member, or may be formed of a plurality of divisional bodies. For example, the seat portion may be formed of divisional bodies that are front-rear divided at a position between the front end and the rear end. In this case, the lifting element may have all of the plurality of divisional bodies of the seat portion, or may have only a part of the plurality of divisional bodies of the seat portion. In other words, in a case where the seat portion is formed of a plurality of divisional bodies, only a part of the divisional bodies may change in position upward when impact occurs, or all of the divisional bodies may change in position upward when impact occurs.

The lifting element having at least a part of the seat portion has a lift drive portion which changes the position of at least a part of the seat portion upward, in addition to at least a part of the seat portion.

When impact occurs, the lift drive portion may change the position of the entirety of the seat portion upward, or may change the position of only a part of the seat portion upward. When the position of the entirety or a part of the seat portion is changed, the buttocks of the dummy sitting on the seat portion are lifted from directly below.

In this case, the lift drive portion may apply a force to a front end of the seat portion so as to incline the front end upward, or may apply a force to a rear end of the seat portion so as to incline the rear end upward, for example. Alternatively, the lift drive portion may lift the entirety of the seat portion upward.

In a case where the seat portion is formed of a plurality of divisional bodies, the lift drive portion may lift, of the divisional bodies, a front divisional body including the front end of the seat portion, upward, or may lift, of the divisional bodies, a rear divisional body including a rear end of the seat portion, upward.

Alternatively, the lift drive portion may apply a force to a rear end of the front divisional body so as to incline the rear end of the front divisional body upward, or may apply a force to a front end of the rear divisional body so as to incline the front end of the rear divisional body upward.

Further, the seat portion may be formed of three or more divisional bodies arranged in the front-rear direction, and an intermediate divisional body located between a front divisional body and a rear divisional body of the divisional bodies may be lifted upward by the lift drive portion. Only one intermediate divisional body may be provided or a plurality of intermediate divisional bodies may be provided. The lift drive portion may lift the entirety of the intermediate divisional body upward, or may incline a front end or a rear end of the intermediate divisional body upward.

The lift drive portion may change the position of at least a part of the seat portion upward as described above, and the mechanism and the like therefor are not particularly limited. The lift drive portion is, for example, the one including an electric motor, an inflator, or the like as a drive source, but is not limited thereto. Preferably, the lift drive portion operates swiftly when impact occurs, and particularly preferably, the lift drive portion is the one including an inflator as a drive source.

The lift drive portion may have, in addition to the drive source described above, a driven portion which changes the position of at least a part of the seat portion upward by being driven by the drive source. The driven portion may be the seat portion itself, may be integrated with the seat portion, or may be the seat support portion which supports the seat portion.

The seat support portion serving as the driven portion is preferably a seat bar or a seat pan, for example.

Among these, the seat bar is a long member provided under the seat surface of the seat and extending in the width direction of the seat. The seat bar supports the seat portion from the underside and contributes to improvement in the strength of the sitting portion particularly in the width direction.

In a case where the seat bar is the driven portion, when impact occurs, the seat bar driven by the drive source changes in position upward, and at least a part of the seat portion is lifted upward by the seat bar so as to change in position.

The seat pan is a plate-shaped member which is provided under the seat surface of the seat and extends in the width direction and the front-rear direction of the seat. The seat pan supports the seat portion from the underside and contributes to improvement in the strength of the sitting portion in the width direction and the front-rear direction.

In a case where the seat pan is the driven portion, when impact occurs, at least a part of the seat pan driven by the drive source changes in position upward. The entirety of the seat pan may change in position upward, or for example, the seat pan may be inclined with one end as a base so that the other end changes in position upward. At least a part of the seat pan is changed in position upward, and accordingly, at least a part of the seat portion is lifted upward by the seat pan so as to change in position.

For example, in a case where the drive source is an electric motor, a drive force transmission mechanism such as a rack-and-pinion mechanism or a cam mechanism is desirably interposed between the electric motor as the drive source and the seat bar or the seat pan as the driven portion. The drive force transmission mechanism is a part of the lift drive portion.

The drive force transmission mechanism converts the drive force of the drive source to an upward force and transmits the upward force to the seat bar or the seat pan, whereby at least a part of the seat bar or the seat pan changes in position upward.

The inflator is a device for producing any kind of inflation fluid such as gas, as described above. In a case where the drive source is an inflator, an airbag-like drive force transmission mechanism is desirably interposed between the inflator as the drive source and the seat bar or the seat pan as the driven portion. The drive force transmission mechanism is also a part of the lift drive portion.

The airbag-like drive force transmission mechanism is deployed and expanded by the drive force of the drive source, i.e., the inflation fluid. Thus, the drive force transmission mechanism changes the position of at least a part of the seat bar or the seat pan upward.

In a case where the lift drive portion directly changes the position of at least a part of the seat portion upward as described above, the drive force transmission mechanism is desirably interposed between the drive source and the seat portion. In this case, the lift drive portion is considered to let the seat portion itself serve as the driven portion.

As described above, in a case where at least a part of the sitting portion of the seat is used as a part of the lifting element as described above, if the operation speed of the lift drive portion when impact occurs is increased, the buttocks of the dummy are quickly lifted when impact occurs [1]. Also in this case, the lifting element preferably lifts the seat surface of the seat at such a speed that the waist point (e.g., the waist acceleration sensor) in the dummy is lifted by not less than 10 mm in 25 milliseconds when impact occurs. More preferably, the lifting element lifts the seat surface of the seat at such a speed that the waist point is lifted by not less than 20 mm in 25 milliseconds.

Further, in the case where at least a part of the sitting portion of the seat is used as a part of the lifting element as described above, if at least a part of the sitting portion is greatly changed in position upward by the lift drive portion, the buttocks of the dummy are lifted high when impact occurs [3].

Hereinafter, the occupant posture regulation apparatus of the present disclosure will be described using specific examples.

### Embodiment 1

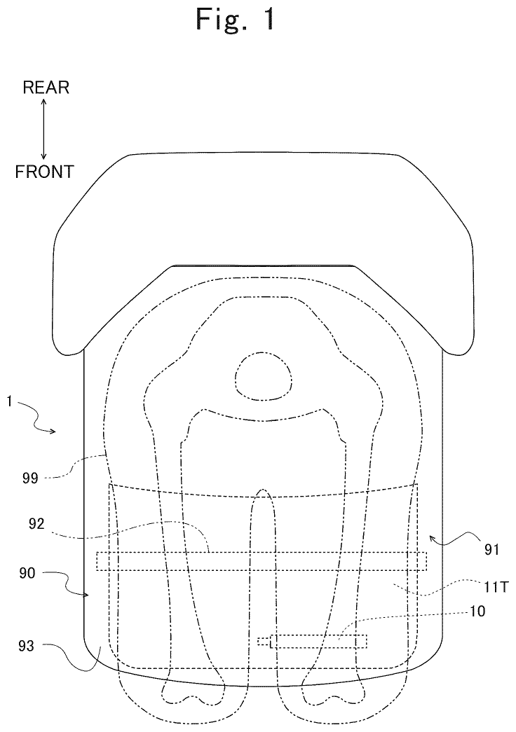

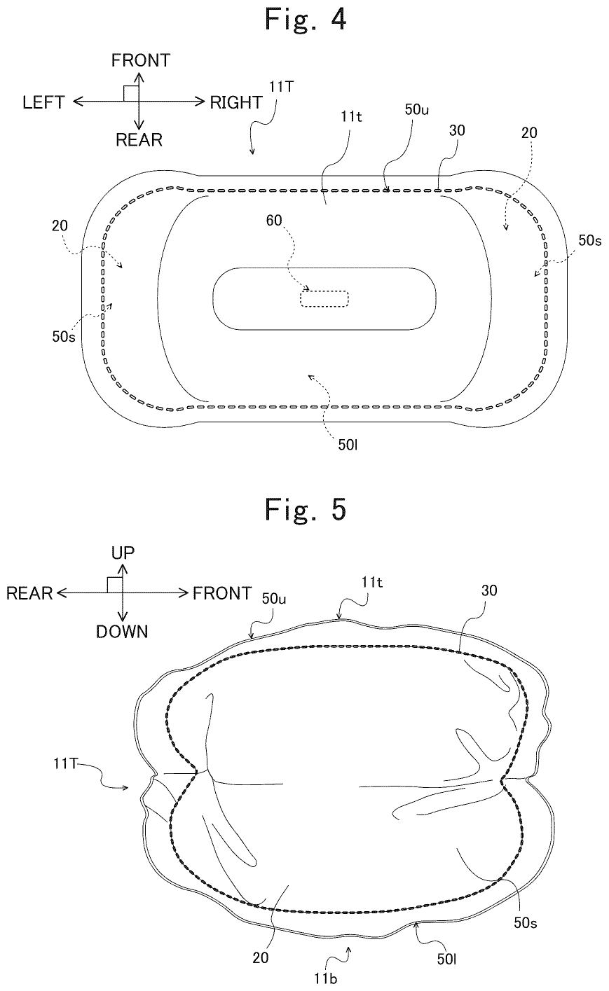

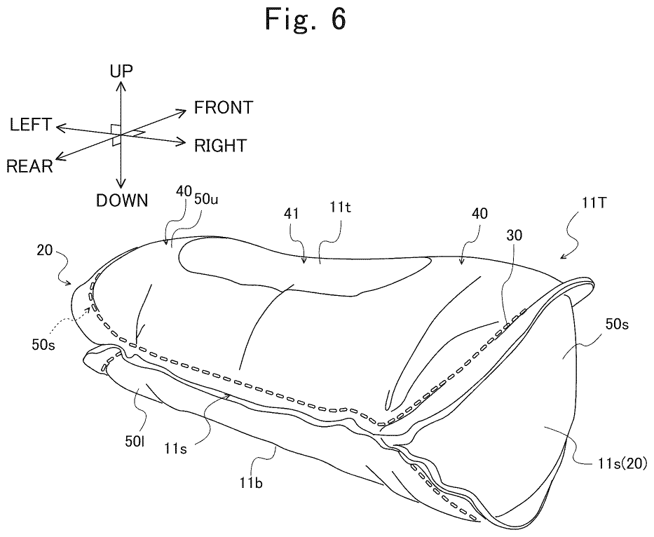

An occupant posture regulation apparatus of embodiment 1 includes the seat cushion airbag device as the lifting element, and includes the seat. FIG. 1 schematically illustrates a state where the occupant posture regulation apparatus of embodiment 1 is seen from above. FIG. 2 and FIG. 3 schematically illustrate a state where the occupant posture regulation apparatus of embodiment 1 is seen laterally. FIG. 2 shows the occupant posture regulation apparatus of embodiment 1 when the airbag is in a normal state, and FIG. 3 shows the occupant posture regulation apparatus of embodiment 1 when impact occurs and the airbag is deployed and expanded. FIG. 4 schematically shows a state where the airbag of the occupant posture regulation apparatus of embodiment 1 is seen from above, FIG. 5 schematically shows a state where the airbag of the occupant posture regulation apparatus of embodiment 1 is seen laterally, and FIG. 6 schematically illustrates a state where the airbag of the occupant posture regulation apparatus of embodiment 1 is seen laterally from the rear side.

Hereinafter, in embodiment 1, up, down, left, right, front, and rear refer to up, down, left, right, front, and rear shown in the drawings. The left-right direction coincides with the width direction.

The occupant posture regulation apparatus of embodiment 1 includes a seat cushion airbag device 1 as the lifting element, and a seat 90.

As shown in FIG. 1, the seat cushion airbag device 1 includes the three-dimensional airbag 11T and an inflation fluid production source 10.

The seat cushion airbag device 1 of the occupant posture regulation apparatus of embodiment 1 is mounted to the seat 90 for vehicle, and more specifically, is provided under a seat portion 95 in a sitting portion 91 of the seat 90. The seat surface 93 of the sitting portion 91 is formed by an upper surface of the seat portion 95. Therefore, the seat cushion airbag device 1 of the occupant posture regulation apparatus of embodiment 1 is considered to be provided under the seat surface 93 in the sitting portion 91.

The three-dimensional airbag 11T is located above a seat bar 92 extending in the width direction near a center part in the front-rear direction inside the sitting portion 91. Therefore, the seat cushion airbag 11 is considered to be located in a front area which is an area between the center part and a front end in the front-rear direction of the sitting portion 91.

The inflation fluid production source 10 is provided inside the three-dimensional airbag 11T and is located on the front side relative to the seat bar 92.

The inflation fluid production source 10 of the seat cushion airbag device 1 is an inflator that produces gas as the inflation fluid. The inflation fluid production source 10 is connected to a control device (not shown) for deploying and expanding the three-dimensional airbag 11T and operates by being supplied with power. The control device is an electronic control unit (ECU) for a vehicle.

As shown in FIG. 4 and FIG. 5, the three-dimensional airbag 11T is formed by sewing the upper sheet 50u, the lower sheet 501, the two gusset member 50s, and a tether 60 together.

The upper sheet 50u forms the top portion 11t of the three-dimensional airbag 11T, and the lower sheet 501 forms the bottom portion 11b of the three-dimensional airbag 11T.

The upper sheet 50u, the lower sheet 501, and the gusset members 50s are made of woven fabric of polyester. Among these, the upper sheet 50u and the lower sheet 501 have substantially the same shape with the long-side direction along the left-right direction and with the short-side direction along the front-rear direction. Therefore, the long-side direction of the seat cushion airbag 11 is considered to be along the width direction.

As shown in FIG. 4, FIG. 5, and FIG. 6, the upper sheet 50u and the lower sheet 501 are integrated by being sewed together at front side parts and rear side parts of the peripheral edges. The upper sheet 50u and the lower sheet 501 are considered to be integrated by being sewed together at both ends in the short-side direction.

The gusset members 50s are provided one by one at both ends in the long-side direction of the three-dimensional airbag 11T. An upper side part of each gusset member 50s is sewed together with an end in the long-side direction of the upper sheet 50u so as to be integrated. A lower side part of each gusset member 50s is sewed together with an end in the long-side direction of the lower sheet 501 so as to be integrated.

As shown in FIG. 4, the seams 30 of the upper sheet 50u, the lower sheet 501, and the two gusset members 50s are formed around the entire periphery in the peripheral direction along the peripheral edges of the upper sheet 50u and the lower sheet 501. As shown in FIG. 5, the seam 30 is considered to be formed around the entire periphery in the peripheral direction along the peripheral edge of each gusset member 50s. Thus, the three-dimensional airbag 11T forms substantially a box shape.

In the three-dimensional airbag 11T, at both ends in the short-side direction, the seams 30 of the upper sheet 50u and the lower sheet 501, and parts near the seams 30, form parts of the side portion 11s. In addition, at both ends in the longitudinal direction of the three-dimensional airbag 11T, parts between the seams 30 of the upper sheet 50u and the gusset members 50s and the seams 30 of the lower sheet 501 and the gusset members 50s form the remaining parts of the side portion 11s. The remaining parts correspond to the standing walls 20 extending in the up-down direction.

As shown in FIG. 4, in the three-dimensional airbag 11T, the top portion 11t and the bottom portion 11b are connected by the tether 60. The tether 60 is provided inside the three-dimensional airbag 11T.

The three-dimensional airbag 11T is folded in a normal state. When being supplied with the inflation fluid from the inflation fluid production source 10, the three-dimensional airbag 11T is deployed and expanded as shown in FIG. 5 and FIG. 6.

The three-dimensional airbag 11T is provided in the sitting portion 91 with the long-side direction thereof along the left-right direction which is the width direction. A center part in the long-side direction of the top portion 11t and a center part in the long-side direction of the bottom portion 11b are connected by the tether 60. Therefore, at the time of deployment and expansion, the center part in the long-side direction of the top portion 11t is at a lower position in the upward direction, as compared to both ends in the long-side direction of the top portion 11t.

That is, the top portion 11t of the three-dimensional airbag 11T has rising portions 40 at both ends in the long-side direction, as shown in FIG. 6. At the time of deployment and expansion, the rising portions 40 are at higher positions in the upward direction than a center part 41 in the long-side direction.

The three-dimensional airbag 11T has the standing walls 20 extending in the up-down direction, in areas located at both ends in the long-side direction of the side portion 11s. At the time of deployment and expansion, the standing walls 20 deform in the up-down direction. Therefore, the deformation direction of the three-dimensional airbag 11T at the time of deployment and expansion is guided in the up-down direction by the standing walls 20.

Therefore, in the three-dimensional airbag 11T, the position in the upward direction of the top portion 11t at the time of deployment and expansion is high. Thus, the occupant posture regulation apparatus of embodiment 1 lifts the seat surface 93 of the seat 90 high in the upward direction by the lifting element, i.e., the seat cushion airbag device 1, thereby lifting the buttocks 99b of the dummy 99 sitting on the seat 90 high.

Even if the internal pressure of the three-dimensional airbag 11T at the time of deployment and expansion is not so high, the position in the upward direction of the top portion 11t is sufficiently high. Thus, the occupant posture regulation apparatus of embodiment 1 lifts the buttocks 99b of the dummy 99 sitting on the seat 90 high and quickly, by the lifting element, i.e., the seat cushion airbag device 1.

As shown in FIG. 2, the dummy 99 has a waist acceleration sensor SW at the waist 99w thereof, and has a chest acceleration sensor SC at the chest 99c thereof. The waist acceleration sensor SW is present at the waist point in the dummy 99, and the chest acceleration sensor SC is present at the chest point in the dummy 99.

The seat cushion airbag device 1 of the occupant posture regulation apparatus of embodiment 1 deploys and expands the three-dimensional airbag 11T at such a speed that the waist point, i.e., the waist acceleration sensor SW, in the dummy 99 is lifted by not less than 20 mm in 25 milliseconds. That is, the speed at which the three-dimensional airbag 11T is deployed and expanded is fast. Owing to this as well, the lifting element of the occupant posture regulation apparatus of embodiment 1 lifts the buttocks 99b of the dummy 99 sitting on the seat 90 high and quickly.

In the occupant posture regulation apparatus of embodiment 1, through the above cooperation, a distance H in the vertical direction between the waist acceleration sensor SW and the chest acceleration sensor SC in the dummy 99, in other words, the distance in the vertical direction between the waist point and the chest point, becomes smaller when impact occurs than in a normal case. Specifically, in the occupant posture regulation apparatus of embodiment 1, when impact occurs, the distance H in the vertical direction between the waist acceleration sensor SW and the chest acceleration sensor SC is shorter than in a normal case by not less than 10 mm.

That is, with the occupant posture regulation apparatus of embodiment 1, the dummy 99 sitting on the seat 90 as shown in FIG. 2 comes into a stooped state in which the back bows frontward as shown in FIG. 3, when impact occurs. As a matter of course, the occupant sitting on the seat 90 also comes into a stooped state in the same manner, when impact occurs.

When the dummy 99 is in a stooped state, the shoulder strap 94s is stretched between the shoulder 99s and the waist 99w of the dummy 99 without coming into a state of being fitted along the chest 99c of the dummy 99. Therefore, at this time, a gap is formed between the shoulder strap 94s and the chest 99c located between the shoulder 99s and the waist 99w. Thus, the chest 99c of the dummy 99 is prevented or inhibited from being strongly pressed by tension of the shoulder strap 94s, whereby the chest of the occupant is prevented or inhibited from being strongly pressed. That is, the occupant posture regulation apparatus of embodiment 1 reduces a load applied to the occupant when impact occurs.

When impact occurs, the waist of the dummy wearing the seat belt moves frontward first due to the inertia, and then is brought back to the rear side. In some cases, the waist of the dummy repeats the front-rear movements a plurality of times.

With the seat cushion airbag device 1 of the occupant posture regulation apparatus of embodiment 1, a state in which the distance H in the vertical direction between the waist acceleration sensor SW and the chest acceleration sensor SC in the dummy 99 is smaller than in a normal case was kept for, specifically, not less than 55 milliseconds until the first frontward movement of the waist point in the dummy stopped. Thus, the stooped state of the dummy 99 is kept for a sufficiently long time, and the chest 99c of the dummy 99 is reliably prevented or inhibited from being strongly pressed by tension of the shoulder strap 94s.

### Embodiment 2

An occupant posture regulation apparatus of embodiment 2 includes, as the lifting element, the seat portion and the lift drive portion, instead of the seat cushion airbag device. Except this, the occupant posture regulation apparatus of embodiment 2 is substantially the same as the occupant posture regulation apparatus of embodiment 1.

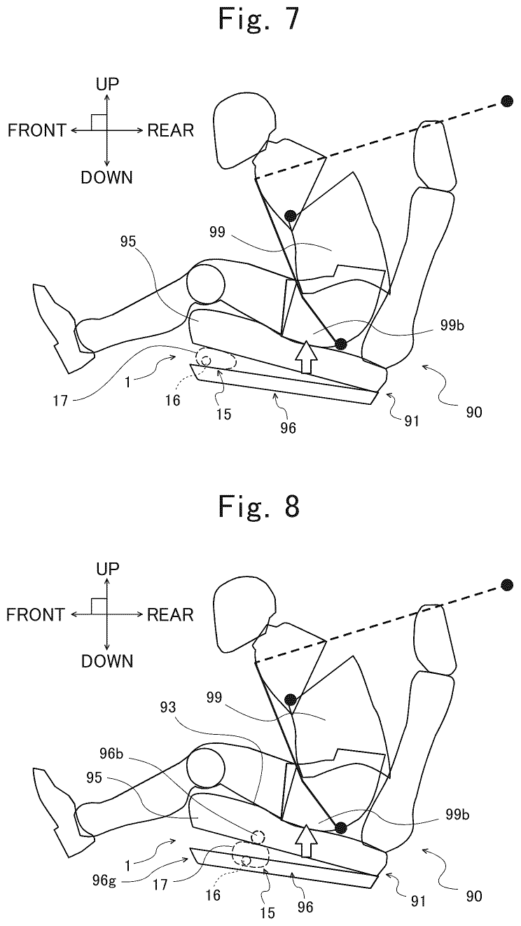

FIG. 7 schematically illustrates the occupant posture regulation apparatus of embodiment 2.

Hereinafter, the occupant posture regulation apparatus of embodiment 2 will be described focusing on a difference from embodiment 1.

As shown in FIG. 7, the occupant posture regulation apparatus of embodiment 2 includes the seat portion 95 and a lift drive portion 15, as the lifting element 1.

More specifically, the seat 90 of the occupant posture regulation apparatus of embodiment 2 includes the seat portion 95 and the seat support portion 96. The seat support portion 96 is a part supporting the seat portion 95 from the underside, of the sitting portion 91 of the seat 90. The seat portion 95 is configured to incline relative to the seat support portion 96 so that the front end of the seat portion 95 faces upward, about the inclination axis (not shown) located on the rear side of the seat portion 95.

The lift drive portion 15 is provided between the seat portion 95 and the seat support portion 96, and has the drive source 16 formed of an inflator, and an airbag-like drive force transmission mechanism 17. The drive force transmission mechanism 17 is located at a front-side position, between the seat portion 95 and the seat support portion 96.

As with various kinds of airbag devices, the drive source 16, i.e., the inflator, is connected to the ECU, and when impact occurs, the drive source 16 produces an inflation fluid and supplies the inflation fluid to the airbag-like drive force transmission mechanism 17. The drive force transmission mechanism 17 supplied with the inflation fluid is deployed and expanded between the seat support portion 96 and the seat portion 95. When the drive force transmission mechanism 17 is deployed and expanded, the seat portion 95 is lifted from below and inclines so that the front end faces upward. Thus, the lifting element 1 lifts the buttocks 99b of the dummy 99 sitting on the seat 90 high.

The lifting element 1 of the occupant posture regulation apparatus of embodiment 2 also deploys and expands the drive force transmission mechanism 17 at such a speed that the waist point, i.e., the waist acceleration sensor, in the dummy 99 is lifted by not less than 20 mm in 25 milliseconds. Therefore, the occupant posture regulation apparatus of embodiment 2 also lifts the buttocks 99b of the dummy 99 sitting on the seat 90 high and quickly.

Also in the occupant posture regulation apparatus of embodiment 2, when impact occurs, the distance H in the vertical direction between the waist acceleration sensor and the chest acceleration sensor in the dummy 99 is shorter than in a normal case by not less than 10 mm.

Therefore, also with the occupant posture regulation apparatus of embodiment 2, the dummy 99 sitting on the seat 90 comes into a stooped state when impact occurs. In the same manner, the occupant sitting on the seat 90 comes into a stooped state when impact occurs.

Thus, the occupant posture regulation apparatus of embodiment 2 prevents or inhibits the chest of the occupant from being strongly pressed when impact occurs, thereby reducing a load applied to the occupant when impact occurs.

### Embodiment 3

The occupant posture regulation apparatus of embodiment 3 includes the seat bar as the lifting element, and is substantially the same as the occupant posture regulation apparatus of embodiment 2 except the lifting element.

FIG. 8 schematically illustrates the occupant posture regulation apparatus of embodiment 3.

Hereinafter, the occupant posture regulation apparatus of embodiment 3 will be described focusing on a difference from embodiment 2.

As shown in FIG. 8, the occupant posture regulation apparatus of embodiment 3 includes, as the lifting element 1, a seat bar 96b which is a part of the seat support portion 96, and the lift drive portion 15.

The seat bar 96b is a metal member having high strength and high rigidity. The seat bar 96b has a long shape and extends in the width direction of the sitting portion 91, under the seat portion 95 and at a front side part of the seat portion 95. The seat bar 96b is changeable in position in the upward direction relative to the other part (referred to as a general support portion 96g) of the seat support portion 96.

The lift drive portion 15 is provided under the seat bar 96b, and has the drive source 16 formed of an inflator, and the airbag-like drive force transmission mechanism 17. The drive force transmission mechanism 17 is located directly below the seat bar 96b and on the upper side of the general support portion 96g.

When impact occurs, the drive source 16, i.e., the inflator, produces an inflation fluid, and supplies the inflation fluid to the airbag-like drive force transmission mechanism 17. Then, the drive force transmission mechanism 17 is deployed and expanded under the seat bar 96b. When the drive force transmission mechanism 17 is deployed and expanded, the seat bar 96b changes in position upward, so that the seat surface 93 of the seat portion 95 is lifted upward. Thus, the occupant posture regulation apparatus of embodiment 3 also lifts the buttocks 99b of the dummy 99 sitting on the seat 90 high.

The lifting element 1 of the occupant posture regulation apparatus of embodiment 3 also deploys and expands the drive force transmission mechanism 17 at such a speed that the waist acceleration sensor in the dummy 99 is lifted by not less than 20 mm in 25 milliseconds. Therefore, the occupant posture regulation apparatus of embodiment 3 also lifts the buttocks 99b of the dummy 99 sitting on the seat 90 high and quickly.

Also in the occupant posture regulation apparatus of embodiment 3, when impact occurs, the distance H in the vertical direction between the waist acceleration sensor and the chest acceleration sensor in the dummy 99 is shorter than in a normal case by not less than 10 mm.

Therefore, also with the occupant posture regulation apparatus of embodiment 3, the dummy 99 sitting on the seat 90 comes into a stooped state when impact occurs. In the same manner, the occupant sitting on the seat 90 comes into a stooped state when impact occurs.

Thus, the occupant posture regulation apparatus of embodiment 3 prevents or inhibits the chest of the occupant from being strongly pressed when impact occurs, thereby reducing a load applied to the occupant when impact occurs.

### Embodiment 4

An occupant posture regulation apparatus of embodiment 4 includes the seat pan as the lifting element, and is substantially the same as the occupant posture regulation apparatus of embodiment 2 except the lifting element.

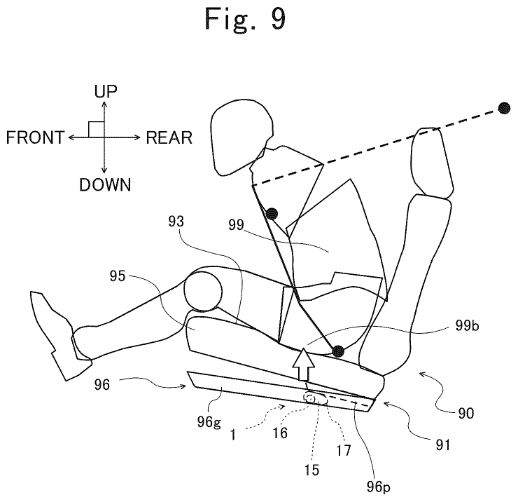

FIG. 9 schematically illustrates the occupant posture regulation apparatus of embodiment 4.

Hereinafter, the occupant posture regulation apparatus of embodiment 4 will be described focusing on a difference from embodiment 2.

As shown in FIG. 9, the occupant posture regulation apparatus of embodiment 4 includes, as the lifting element 1, a seat pan 96p which is a part of the seat support portion 96, and the lift drive portion 15.

The seat pan 96p is a metal member having high strength and high rigidity. The seat pan 96p has a flat plate shape and extends in the front-rear direction and the width direction of the sitting portion 91, under the seat portion 95 and at a rear part of the seat portion 95. The seat pan 96p is configured to incline so that a front end faces upward, about an inclination axis (not shown) located on the rear side of the seat pan 96p. Therefore, the seat pan 96p is considered to be changeable in position in the upward direction relative to the general support portion 96g.

The lift drive portion 15 is provided under the seat pan 96p, and has the drive source 16 formed of an inflator, and the airbag-like drive force transmission mechanism 17. The drive force transmission mechanism 17 is located below the front side of the seat pan 96p.

When impact occurs, the drive source 16, i.e., the inflator, produces an inflation fluid, and supplies the inflation fluid to the airbag-like drive force transmission mechanism 17. Then, the drive force transmission mechanism 17 is deployed and expanded under the front side of the seat pan 96p. When the drive force transmission mechanism 17 is deployed and expanded, the seat pan 96p inclines with the front end facing upward, so that the seat surface 93 of the seat portion 95 is lifted upward. Thus, the occupant posture regulation apparatus of embodiment 4 also lifts the buttocks 99b of the dummy 99 sitting on the seat 90 high from directly below.

The lifting element 1 of the occupant posture regulation apparatus of embodiment 4 also deploys and expands the drive force transmission mechanism 17 at such a speed that the waist acceleration sensor in the dummy 99 is lifted by not less than 20 mm in 25 milliseconds. Therefore, the occupant posture regulation apparatus of embodiment 4 also lifts the buttocks 99b of the dummy 99 sitting on the seat 90 high and quickly from directly below.

Also in the occupant posture regulation apparatus of embodiment 4, when impact occurs, the distance H in the vertical direction between the waist acceleration sensor and the chest acceleration sensor in the dummy 99 is shorter than in a normal case by not less than 10 mm.

Therefore, also with the occupant posture regulation apparatus of embodiment 4, the dummy 99 sitting on the seat 90 comes into a stooped state when impact occurs. In the same manner, the occupant sitting on the seat 90 comes into a stooped state when impact occurs.

Thus, the occupant posture regulation apparatus of embodiment 4 prevents or inhibits the chest of the occupant from being strongly pressed when impact occurs, thereby reducing a load applied to the occupant when impact occurs.

While the present disclosure has been described above, the present disclosure is not limited to the embodiments and the like described above. The elements described in the embodiments and the like may be picked out and combined as appropriate, or may be subjected to various modifications without deviating from the scope of the present disclosure.

The description of the present disclosure discloses not only technical features shown by the reference relationship of the claims at the time of filing of the present application but also technical features obtained by combining matters described in the claims as appropriate.

1. An occupant posture regulation apparatus for regulating a posture of an occupant sitting on a seat when impact occurs on a vehicle, the occupant posture regulation apparatus comprising a lifting element configured to operate when the impact occurs, wherein
when the impact occurs, the lifting element lifts a seat surface of the seat upward so that a distance in a vertical direction between a waist point and a chest point in a THOR50M dummy sitting on the seat becomes smaller than in a normal case.

2. The occupant posture regulation apparatus according to claim 1, wherein
when the impact occurs, the lifting element lifts the seat surface of the seat upward at such a speed that the waist point in the THOR50M dummy is lifted by not less than 20 mm in 25 milliseconds.

3. The occupant posture regulation apparatus according to claim 1, wherein
the lifting element is a seat cushion airbag device which has an airbag provided under the seat surface in the seat and configured to be deployed and expanded when the impact occurs.

4. The occupant posture regulation apparatus according to claim 1, wherein
the lifting element has a seat portion including the seat surface of the seat, and
at least a part of the seat portion changes in position upward when the impact occurs.

5. The occupant posture regulation apparatus according to claim 1, wherein
the lifting element has a seat bar provided under the seat surface in the seat and extending in a width direction of the seat, and
the seat bar changes in position upward when the impact occurs.

6. The occupant posture regulation apparatus according to claim 1, wherein
the lifting element has a seat pan provided under the seat surface in the seat and extending in a width direction and a front-rear direction of the seat, and
at least a part of the seat pan changes in position upward when the impact occurs.

7. The occupant posture regulation apparatus according to claim 1, wherein
when the impact occurs, the lifting element lifts the seat surface upward so that a state in which a distance in a vertical direction between the waist point and the chest point in the THOR50M dummy is smaller than in the normal case is kept until first frontward movement of the waist point relative to the vehicle stops.

8. The occupant posture regulation apparatus according to claim 1, further comprising the seat and a seat belt, in addition to the lifting element.
